(19) United States
(12) Patent Application Publication
(10) Pub. No.: US 2014/0133396 A1
(43) Pub. Date: May 15, 2014

(54) Method and system for configuring route to base station in operation maintenance center

(71) Applicant: Jie Liu, Shenzhen (CN)

(72) Inventor: Jie Liu, Shenzhen (CN)

(73) Assignee: ZTE CORPORATION, Shenzhen, Guangdong (CN)

(21) Appl. No.: 14/118,407

(22) PCT Filed: May 11, 2012
(86) PCT No.: PCT/CN2012/075407

§ 371 Date: Nov. 18, 2013

(30) Foreign Application Priority Data
May 18, 2011 (CN) 201110128827.7

(51) Int. Cl. H04W 40/24; H04L 29/12

(52) U.S. Cl. CPC H04W 40/246; H04L 61/2007
USPC 370/328

(57) ABSTRACT

A method for configuring a route to a base station in an OMC is described. The method includes: an IP address of a base station and a mask of the base station are acquired; an IP address of a routing gateway is determined, wherein the IP address of the routing gateway and an address of an OMC server are on a same network segment; and a route from the OMC server to the base station is obtained according to the IP address and the mask of the base station and the IP address of the routing gateway. A system for configuring a route to a base station in an OMC is also described. With the method and system, a base station can communicate with an OMC server, and can download and update a version automatically.

### TECHNICAL FIELD

The disclosure relates to the field of network communication, and in particular to a method and system for configuring a route to a base station in an Operation Maintenance Center (OMC).

### BACKGROUND

At present, domestic Code Division Multiple Access (CDMA) systems have reached a better level in outdoor coverage. However, a relatively small investment is made in indoor coverage and there are no indoor coverage systems in many new buildings, the indoor coverage therefore becomes the greatest challenge for the improvement of current network quality. In term of the type of CDMA products, it is necessary to develop a low-capacity and low-cost micro base station to meet indoor coverage requirement of a wireless system. Accordingly, a micro CDMA base station emerges at the right moment.

To support matching check and automatic updating of a version, the micro base station may update its version automatically when powered on. However, when an original macro station updates a version, the original macro station needs to manually synchronize background data to a network element. And during a synchronization process, data are loaded to an Operation Main Processor (OMP) of a Base Station Controller (BSC) at first, and then are distributed to base stations. However, for a micro base station, the micro base station reports its own running version number to a background OMC; the background OMC determines according to the reported version number whether to send a version download message to the base station; and the base station downloads a latest version from the OMC to covers a backup version, and further activates the downloaded latest version automatically. In this way, the base station needs to communicate with a server directly without the OMP.

Since manually adding a system routing table is low-efficiency, is easy to make an error and is not convenient for a user to view and modify, it is necessary to develop a new route configuration technique, so that a base station can communicate with a server directly, and download and update a version automatically, so as to achieve self-adaption and self-configuration.

### SUMMARY

In view of this, the disclosure is intended to provide a method and system for configuring a route to a base station in an OMC, so as to enable a base station to communicate with a server and enable the base station to automatically download and update a version.

To this end, the technical solutions of the disclosure are as follows.

A method for configuring a route to a base station in an OMC includes:

an Internet Protocol (IP) address of a base station and a mask of the base station are acquired;

an IP address of a routing gateway is determined, wherein the IP address of the routing gateway and an address of an OMC server are on a same network segment; and

a route from the OMC server to the base station is obtained according to the IP address and the mask of the base station and the IP address of the routing gateway.

Furthermore, the step that an IP address of a routing gateway is determined may include:

an IP address of a routing gateway input by a user is determined as the IP address of the routing gateway; or

the OMC determines an IP address of a routing gateway generated by the OMC automatically as the IP address of the routing gateway.

Furthermore, the route from the OMC server to the base station may be obtained by taking the IP address of the routing gateway as a routing gateway, by taking a network segment address determined based on the IP address and the mask of the base station as a destination address of the route, and by taking the mask of the base station as a routing mask.

Furthermore, after the route from the OMC server to the base station is obtained, the method may further include:

the route from the OMC server to the base station is stored to an operating system routing table of the OMC server and a local database.

Furthermore, the route from the OMC server to the base station may be stored to the local database at first, and then may be loaded to the operating system routing table of the OMC server.

Furthermore, the route from the OMC server to the base station in the local database may be further reloaded to the operating system routing table of the OMC server.

A system for configuring a route to a base station in an OMC includes:

a base station information acquiring module, configured to acquire an IP address and a mask of a base station;

a gateway address determining module, configured to determine an IP address of a routing gateway, wherein the IP address of the routing gateway and an address of an OMC server are on a same network segment; and

a route-to-base-station determining module, configured to obtain a route from the OMC server to the base station according to the IP address and the mask of the base station and the IP address of the routing gateway.

Furthermore, the route-to-base-station determining module may include: a route determination sub-module, configured to obtain the route from the OMC server to the base station by taking the IP address of the routing gateway as a routing gateway, by taking a network segment address determined based on the IP address and the mask of the base station as a destination address of the route, and by taking the mask of the base station as a routing mask.

Furthermore, the route-to-base-station determining module may further include: a route storing sub-module, configured to store the obtained route from the OMC server to the base station to a local database at first, and then load the stored route to an operating system routing table of the OMC server.

Furthermore, the route-to-base-station determining module may further include: a route reloading sub-module, configured to reload the route from the OMC server to the base station in the local database to the operating system routing table of the OMC server.

The disclosure has the following advantages:

the disclosure proposes a method and system for configuring a route to a base station in an OMC, so as to enable the base station to communicate with a server. The base station can download a version of the base station from an OMC server automatically, so as to achieve self-adaption and self-configuration. Therefore, the efficiency of configuring a route to a base station is improved, and data stability is ensured. Furthermore, more intuitive feeling is brought to users by storing the routing table in the local database. And the disclosure especially lays a good foundation for use and launch of the indoor micro base station.

### BRIEF DESCRIPTION OF THE DRAWINGS

FIG. 1 is a schematic flowchart of a method of the disclosure according to an embodiment; and

FIG. 2 is a schematic diagram showing a structure of a system of the disclosure according to an embodiment.

### DETAILED DESCRIPTION

The disclosure is further elaborated below in combination with the drawings and specific embodiments.

In the method of the disclosure, an OMC acquires an IP address and a mask of a base station through a local database, and the OMC generates a routing destination address according to a network segment determined by the IP address and the mask of the base station. In this way, only one routing record needs to be added when a plurality of base stations belong to the same network segment. A routing mask is the mask address corresponding to the base station. An address of a routing gateway is filled in by a user according to an address of a server where the OMC is located, or an address of a routing gateway is generated by the OMC automatically. The address of the routing gateway needs to be on the same network segment with the address of the server.

The OMC automatically generates, according to the IP address and the mask of the base station and the address of the routing gateway, information of a route to the base station in the OMC server where the OMC is located, wherein the address of the routing gateway is on the same network segment with the address of the OMC server. At the same time, routing added by the OMC server will also be recorded in the local database, which is convenient for a user to view and modify.

Specifically, after the OMC generates the information of the route to the base station according to the IP address and the mask of the base station and the address of the routing gateway that is on the same network segment with the address of the OMC server, the information of the route to the base station may be stored in an operating system routing table of the OMC server directly and backed up to the local database at the same time, or the information of the route to the base station may be stored in the local database at first and then be loaded to the operating system routing table of the OMC server. For the later one, the routes added by the OMC server are divided into permanent routes and temporary routes. If a route added by the OMC server is a permanent route, the permanent route originally added does not disappear after the OMC server is restarted. If a route added by the OMC server is a temporary route, the temporary route originally added will disappear after the OMC server is restarted, and the OMC may add a temporary route to the operating system of the OMC server automatically according to the information of the route stored in the local database. If a route fails to be added automatically due to change of the IP address of the OMC server and the like, a record may be made in an OMC log and a route loading condition, such as whether it is configured successfully, is displayed on a route querying page.

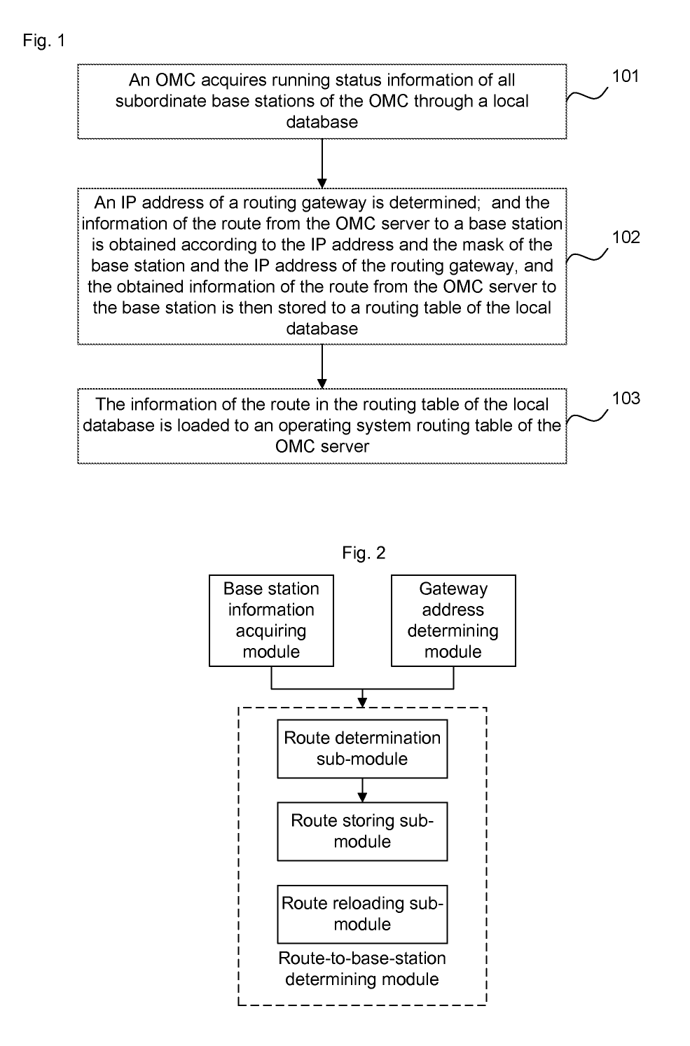

An embodiment of the method of the disclosure is given below with reference to FIG. 1. As shown in FIG. 1, a method for configuring a route to a base station in an OMC according to the disclosure specifically includes the following steps:

Step 101: An OMC acquires running status information of all subordinate base stations of the OMC through a local database, wherein the running status information includes IP addresses of the base stations and the masks of the base stations.

Step 102: An IP address of a routing gateway is determined, wherein the IP address of the routing gateway is on the same network segment with an address of an OMC server; and the information of the route from the OMC server to a base station is obtained according to the IP address and the mask of the base station and the IP address of the routing gateway, and the obtained information of the route from the OMC server to the base station is then stored to a routing table of the local database.

Specifically, if a destination address of the route is a Window system of a specific address, the step in an embodiment is as follows:

the information of the route from the OMC server to the base station is determined by taking an IP address of a routing gateway input by a user as a routing gateway, by taking a network segment address determined according to the IP address of the base station and the mask of the base station as a destination address of the route, and by taking the mask of the base station as a routing mask, and the information of the route from the OMC server to the base station is stored to the routing table of the local database.

If a destination address of the route is a Unix system of a specific address, the step in an embodiment is as follows:

the information of the route from the OMC server to the base station is determined by taking an IP address of a routing gateway input by a user as a routing gateway, by taking the mask of the base station as a routing mask, and according to a network segment address determined by a destination address of the route and the routing mask and a network segment address determined by the IP address of the base station and the mask of the base station, wherein the network segment address determined by a destination address of the route and the routing mask and the network segment address determined by the IP address of the base station and the mask of the base station are on the same network segment, and the information of the route from the OMC server to the base station is stored to the routing table of the local database.

Step 103: The information of the route in the routing table of the local database is loaded to an operating system routing table of the OMC server; and when a user adds a route or modifies a piece of information of a route each time, the OMC may load or update the information corresponding to the route automatically. If the added information of the route is a temporary route, the OMC may load the information of the route in the routing table of the local database to the operating system routing table of the OMC server automatically when started. On the OMC, two enabling identifiers, i.e., “Enabled” and “Disabled”, are configured to indicate whether the information corresponding to the route is loaded to the operating system routing table successfully. If a piece of information of the route of the OMC fails to be loaded to the operating system routing table, the OMC will modify a route flag bit in the routing table of the local database in real time to write the piece of information of the route to “Disabled”, and the piece of information of the route is displayed on a client of the OMC and is recorded in a system log for a user to view.

Meanwhile, in order to prevent the routing table information from being modified using an operating system command artificially, thus resulting in inconsistence between actual route configuration of the operating system and the information of the route in the local database of the OMC, the OMC also provides a function of reloading all routes to once reload all the routes recorded in the local database of the OMC to the operating system routing table, so that the information of the route of the operating system is consistent with the information of the route in the local database of the OMC.

When the information of the route of the OMC server is queried and loaded, a multi-thread technique is adopted to read an output with consideration to a data concurrent access condition; and when data stream is read by a process, it should be noted that the data stream should be read at first and then a process waiting method is called to wait for completion of the process; otherwise, the process may be suspended.

FIG. 2 is a schematic diagram showing a structure of a system of the disclosure according to one embodiment. As shown in FIG. 2, the system for configuring a route to a base station in an OMC includes: a base station information acquiring module, a gateway address determining module and a route-to-base-station determining module, wherein

the base station information acquiring module is configured to acquire an IP address of a base station and a mask of the base station;

the gateway address determining module is configured to determine an IP address of a routing gateway, wherein the IP address of the routing gateway and an address of an OMC server are on the same network segment; and

the route-to-base-station determining module is configured to obtain information of a route from the OMC server to the base station according to the IP address and the mask of the base station and the IP address of the routing gateway.

Here, after the route-to-base-station determining module generates the information of the route to the base station according to the IP address of the base station and the mask information of the base station as well as the address of the routing gateway that is on the same network segment with the address of the OMC server, the information of the route to the base station may be stored in an operating system routing table of the OMC server directly and be backed up to a local database at the same time, or the information of the route to the base station is stored in the local database at first and is then loaded to the operating system routing table of the OMC server.

In an embodiment of the disclosure, the route-to-base-station determining module can further include a route determining sub-module, a route storing sub-module and a route reloading sub-module, wherein

the route determining sub-module is configured to obtain information of a route from an OMC server to a base station by taking the IP address of the routing gateway as a routing gateway, by taking the network segment address determined by the IP address of the base station and the mask of the base station as a destination address of the route, and by taking the mask of the base station as a routing mask;

the route storing sub-module is configured to store the obtained information of the route from the OMC server to the base station to a local database at first and then load the obtained information of the route to a operating system routing table of the OMC server; and

the route reloading sub-module is configured to reload the information of the route from the OMC server to the base station in the local database to the operating system routing table of the OMC server, namely, reloading all routes recorded in the local database of the OMC to the operating system routing table of the OMC server once.

It can be seen from the aforementioned embodiments that the method for configuring a route to a base station in an OMC, which is provided by the disclosure in accordance with application characteristics of a wireless OMC system, not only improves an efficiency for configuring an operating system route of an OMC server and ensures data stability, but also brings more intuitive feeling to users and especially lays a certain foundation for use and launch of the indoor micro base station.

Of course, the disclosure can also have many other embodiments, and various corresponding changes and variations may be made by those skilled in the art without departing from the sprit and essence of the disclosure and shall fall within the scope of protection of the claims of the disclosure.

1. A method for configuring a route to a base station in an Operation Maintenance Center (OMC), comprising:
acquiring an Internet Protocol (IP) address and a mask of a base station;
determining an IP address of a routing gateway, wherein the IP address of the routing gateway and an address of an OMC server are on a same network segment; and
obtaining a route from the OMC server to the base station according to the IP address and the mask of the base station and the IP address of the routing gateway.

2. The method according to claim 1, wherein the determining an IP address of a routing gateway comprises:
determining an IP address of a routing gateway input by a user as the IP address of the routing gateway; or
determining, by the OMC, an IP address of a routing gateway generated by the OMC automatically as the IP address of the routing gateway.

3. The method according to claim 1, wherein the obtaining a route from the OMC server to the base station according to the IP address and the mask of the base station and the IP address of the routing gateway comprises:
obtaining the route from the OMC server to the base station by taking the IP address of the routing gateway as a routing gateway, by taking a network segment address determined based on the IP address and the mask of the base station as a destination address of the route, and by taking the mask of the base station as a routing mask.

4. The method according to claim 1, further comprising: after the route from the OMC server to the base station is obtained,
storing, to an operating system routing table of the OMC server and a local database, the route from the OMC server to the base station.

5. The method according to claim 4, wherein the storing, to an operating system routing table of the OMC server and a local database, the route from the OMC server to the base station comprises:
storing the route from the OMC server to the base station to the local database at first, and then loading the route to the operating system routing table of the OMC server.

6. The method according to claim 5, further comprising:
reloading the route from the OMC server to the base station in the local database to the operating system routing table of the OMC server.

7. A system for configuring a route to a base station in an Operation Maintenance Center (OMC), comprising:
a base station information acquiring module, configured to acquire an IP address and a mask of a base station;
a gateway address determining module, configured to determine an IP address of a routing gateway, wherein the IP address of the routing gateway and an address of an OMC server are on a same network segment; and
a route-to-base-station determining module, configured to obtain a route from the OMC server to the base station according to the IP address and the mask of the base station and the IP address of the routing gateway.

8. The system according to claim 7, wherein the route-to-base-station determining module comprises:
a route determination sub-module, configured to obtain the route from the OMC server to the base station by taking the IP address of the routing gateway as a routing gateway, by taking a network segment address determined based on the IP address and the mask of the base station as a destination address of the route, and by taking the mask of the base station as a routing mask.

9. The system according to claim 8, wherein the route-to-base-station determining module further comprises:
a route storing sub-module, configured to store the obtained route from the OMC server to the base station to a local database at first, and then load the stored route to an operating system routing table of the OMC server.

10. The system according to claim 9, wherein the route-to-base-station determining module further comprises:
a route reloading sub-module, configured to reload the route from the OMC server to the base station in the local database to the operating system routing table of the OMC server.

11. The method according to claim 2, further comprising: after the route from the OMC server to the base station is obtained,
storing, to an operating system routing table of the OMC server and a local database, the route from the OMC server to the base station.

12. The method according to claim 3, further comprising: after the route from the OMC server to the base station is obtained,
storing, to an operating system routing table of the OMC server and a local database, the route from the OMC server to the base station.

13. The method according to claim 11, wherein the storing, to an operating system routing table of the OMC server and a local database, the route from the OMC server to the base station comprises:
storing the route from the OMC server to the base station to the local database at first, and then loading the route to the operating system routing table of the OMC server.

14. The method according to claim 12, wherein the storing, to an operating system routing table of the OMC server and a local database, the route from the OMC server to the base station comprises:
storing the route from the OMC server to the base station to the local database at first, and then loading the route to the operating system routing table of the OMC server.

15. The method according to claim 13, further comprising:
reloading the route from the OMC server to the base station in the local database to the operating system routing table of the OMC server.

16. The method according to claim 14, further comprising:
reloading the route from the OMC server to the base station in the local database to the operating system routing table of the OMC server.
